(19) United States
(12) Patent Application Publication
(10) Pub. No.: US 2012/0020489 A1
(43) Pub. Date: Jan. 26, 2012

(54) NOISE CANCELLER AND NOISE CANCELLATION PROGRAM

(76) Inventor: Tomohiro Narita, Tokyo (JP)

(21) Appl. No.: 13/125,820

(22) PCT Filed: Jan. 6, 2009
(86) PCT No.: PCT/JP09/00011

§ 371 Date: Apr. 25, 2011

(51) Int. Cl. G10K 11/16

(52) U.S. Cl. 381/71.1

(57) ABSTRACT

A directivity control unit 10 calculates a main beam signal with its directivity turned toward an object sound direction and a sub-beam signal with its blind spot turned toward the object sound direction from output signals of a plurality of microphones 2 and 3 through signal processing, and a frequency analyzing unit 20 converts them to spectra. A sound source decision unit 30 decides on whether a sound source is voice, stationary noise or unstationary noise from the spectra of the main beam signal and sub-beam signal and outputs as a sound source decision result, and calculates the average spectrum which is a statistic of noise for the main beam signal. An interfering sound removing unit 50 subtracts the average spectrum from the spectrum of the main beam signal to remove interfering sounds.

### TECHNICAL FIELD

The present invention relates to a noise canceller and a noise cancellation program for eliminating noise using a plurality of microphones.

### BACKGROUND ART

Conventionally, voice recognition and hands-free telephone conversation have a problem in that noise superposed on voice can reduce their recognition performance and intelligibleness. As techniques for solving such a problem, various noise cancellation methods have been proposed. One of them is a noise cancellation technique using a plurality of microphones. Generally, using a plurality of microphones can increase a noise suppression effect as compared with a case of using a single microphone.

As a noise cancellation technique using a plurality of microphones, a technique has been known which compares power difference and time difference between inputs to the plurality of microphones, and removes components other than object sounds (see Patent Document 1, for example). The technique carries out frequency analysis of output signals of the plurality of microphones, compares the power differences or time difference between the channels for individual bands, and suppresses unnecessary components by selecting components of an object sound source from the individual channels.

Patent Document 1: Japanese Patent No. 3435357.

A technique disclosed in Patent Document 1, which directly compares the output signals of the microphones with each other, has a problem of reducing noise cancellation capacity because it reduces the power difference or time difference between the object sounds and interfering sounds depending on characteristics of the microphones set up, their set directions and a set spacing between them.

The present invention is implemented to solve the foregoing problems. Therefore it is an object of the present invention to improve the noise cancellation capacity by making the power difference more distinct by comparing emphasized object sounds with interfering sounds in which the object sounds are suppressed by controlling the directivity by signal processing of the output signals of the plurality of microphones. In addition, it enables noise cancellation without altering microphone set positions in spite of variations in the directions of the object sounds by controlling the directivity by the signal processing. Furthermore, it enables removing noise in spite of noise superposed on the object sounds and on a selected band by removing interfering sounds using a statistic of noise.

### DISCLOSURE OF THE INVENTION

A noise canceller in accordance with the present invention is configured to include: a directivity control unit for calculating a main beam signal with its directivity turned toward an object sound direction and a sub-beam signal with its blind spot turned toward the object sound direction from output signals of a plurality of microphones through signal processing; a frequency analyzing unit for calculating a spectrum of the main beam signal and a spectrum of the sub-beam signal by applying frequency analysis to the main beam signal and the sub-beam signal the directivity control unit calculates; a sound source decision unit for deciding a type of a sound source from the spectrum of the main beam signal and the spectrum of the sub-beam signal the frequency analyzing unit calculates, for outputting the type of the sound source as a sound source decision result, and for calculating a statistic of noise for the main beam signal; and an interfering sound removing unit for removing interfering sounds from the spectrum of the main beam signal by using the spectrum of the sub-beam signal the frequency analyzing unit calculates and the sound source decision result and the statistic of noise supplied from the sound source decision unit.

According to the present invention, the noise canceller can compare the emphasized object sounds with the interfering sounds in which object sounds are suppressed by calculating the main beam signal and sub-beam signal by controlling the directivity through the signal processing. As a result, it can make the power difference distinct, thereby being able to improve the noise cancellation capacity. In addition, even in such a case where the object sound direction varies, it can carry out the noise cancellation without altering the microphone set positions. Furthermore, it can remove the noise even if the noise is superposed upon the object sounds and upon the selected band by removing the interfering sounds using the statistic of noise.

A noise cancellation program in accordance with the present invention causes a computer to function as: a directivity control unit for calculating a main beam signal with its directivity turned toward an object sound direction and a sub-beam signal with its blind spot turned toward the object sound direction from output signals of a plurality of microphones through signal processing; a frequency analyzing unit for calculating a spectrum of the main beam signal and a spectrum of the sub-beam signal by applying frequency analysis to the main beam signal and the sub-beam signal the directivity control unit calculates; a sound source decision unit for deciding a type of a sound source from the spectrum of the main beam signal and the spectrum of the sub-beam signal the frequency analyzing unit calculates, for outputting the type of the sound source as a sound source decision result, and for calculating a statistic of noise for the main beam signal; and an interfering sound removing unit for removing interfering sounds from the spectrum of the main beam signal by using the spectrum of the sub-beam signal the frequency analyzing unit calculates and the sound source decision result and the statistic of noise supplied from the sound source decision unit.

According to the present invention, the noise cancellation program can compare the emphasized object sounds with the interfering sounds in which object sounds are suppressed by calculating the main beam signal and sub-beam signal by controlling the directivity through the signal processing. As a result, it can make the power difference distinct, thereby being able to improve the noise cancellation capacity. In addition, even in such a case where the object sound direction varies, it can carry out the noise cancellation without altering the microphone set positions. Furthermore, it can remove the noise even if the noise is superposed upon the object sounds and upon the selected band by removing the interfering sounds using the statistic of noise.

### BRIEF DESCRIPTION OF THE DRAWINGS

FIG. 1 is a block diagram showing a configuration of a noise canceller 1 of an embodiment 1 in accordance with the present invention;

FIG. 2 is a block diagram showing an internal configuration of a sound source decision unit 30 in the noise canceller 1 of the embodiment 1 in accordance with the present invention;

FIG. 3 is a block diagram showing an internal configuration of an interfering sound removing unit 50 of the noise canceller 1 of the embodiment 1 in accordance with the present invention;

FIG. 4 is a flowchart showing the operation of the directivity control unit 10 and frequency analyzing unit 20 of the noise canceller 1 of the embodiment 1 in accordance with the present invention;

FIG. 5A is a flowchart showing the operation of the sound source decision unit 30 of the noise canceller 1 of the embodiment 1 in accordance with the present invention;

FIG. 5B is a continuation of the flowchart showing the operation of the sound source decision unit 30 of the noise canceller 1 of the embodiment 1 in accordance with the present invention;

FIG. 6 is a flowchart showing the operation of the interfering sound removing unit 50 of the noise canceller 1 of the embodiment 1 in accordance with the present invention;

FIG. 7 is a block diagram showing a configuration of a noise canceller 1 of an embodiment 2 in accordance with the present invention;

FIG. 8 is a flowchart showing the operation of the object sound direction informing unit 60, directivity control unit 10 and frequency analyzing unit 20 of the noise canceller 1 of the embodiment 2 in accordance with the present invention;

FIG. 9 is a block diagram showing a configuration of a noise canceller 1 of an embodiment 3 in accordance with the present invention;

FIG. 10 is a flowchart showing the operation of the language informing unit 80 and interfering sound removing unit 50 of the noise canceller 1 of the embodiment 3 in accordance with the present invention;

FIG. 11 is a block diagram showing an internal configuration of the interfering sound removing unit 50 of a noise canceller 1 of an embodiment 4 in accordance with the present invention;

FIG. 12A is a flowchart showing the operation of the interfering sound removing unit 50 of the noise canceller 1 of the embodiment 4 in accordance with the present invention; and

FIG. 12B is a continuation of the flowchart showing the operation of the interfering sound removing unit 50 of the noise canceller 1 of the embodiment 4 in accordance with the present invention.

### BEST MODE FOR CARRYING OUT THE INVENTION

The best mode for carrying out the invention will now be described with reference to the accompanying drawings to explain the present invention in more detail.

### Embodiment 1

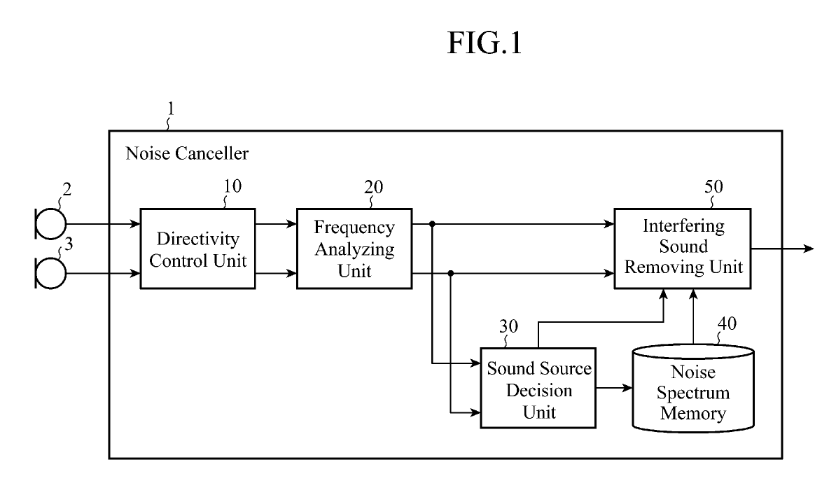

FIG. 1 is a block diagram showing a configuration of the noise canceller 1 of an embodiment 1 in accordance with the present invention. In FIG. 1, the noise canceller 1 is a device for calculating a signal by removing noise from output signals of a plurality of microphones 2 and 3. It comprises a directivity control unit 10, a frequency analyzing unit 20, a sound source decision unit 30, a noise spectrum memory 40, and an interfering sound removing unit 50. Incidentally, although the embodiment 1 employs the microphones 2 and 3 as an example of a plurality of microphones, it can use any number of microphones.

The directivity control unit 10, which is a section for controlling the directivity by applying signal processing to the output signals of the plurality of microphones 2 and 3, outputs a main beam signal with its directivity pointing at the object sound direction and a sub-beam signal with its blind spot pointing at the object sound direction.

The frequency analyzing unit 20 is a section for performing frequency analysis such as FFT (Fast Fourier Transform) on the main beam signal and sub-beam signal the directivity control unit 10 outputs, and supplies the spectrum of the main beam signal and the spectrum of the sub-beam signal to the sound source decision unit 30 and interfering sound removing unit 50, respectively.

The sound source decision unit 30 is a section for making a decision as to whether the sound source is voice or unstationary noise or stationary noise from the spectrum of the main beam signal and the spectrum of the sub-beam signal, and supplies the sound source decision result to the interfering sound removing unit 50 and the spectrum of the main beam signal to the noise spectrum memory 40.

The noise spectrum memory 40 stores statistics of the noise of the main beam signal supplied from the sound source decision unit 30, and supplies an average spectrum, which is a statistic of noise, to the interfering sound removing unit 50.

The interfering sound removing unit 50 is a section for removing the interfering sounds (noise) from the spectrum of the main beam signal output from the frequency analyzing unit 20 by using the sound source decision result output from the sound source decision unit 30, the spectrum of the sub-beam signal output from the frequency analyzing unit 20 and the average spectrum of the noise output from the noise spectrum memory 40, and creates the spectrum of the main beam signal from which the noise is removed.

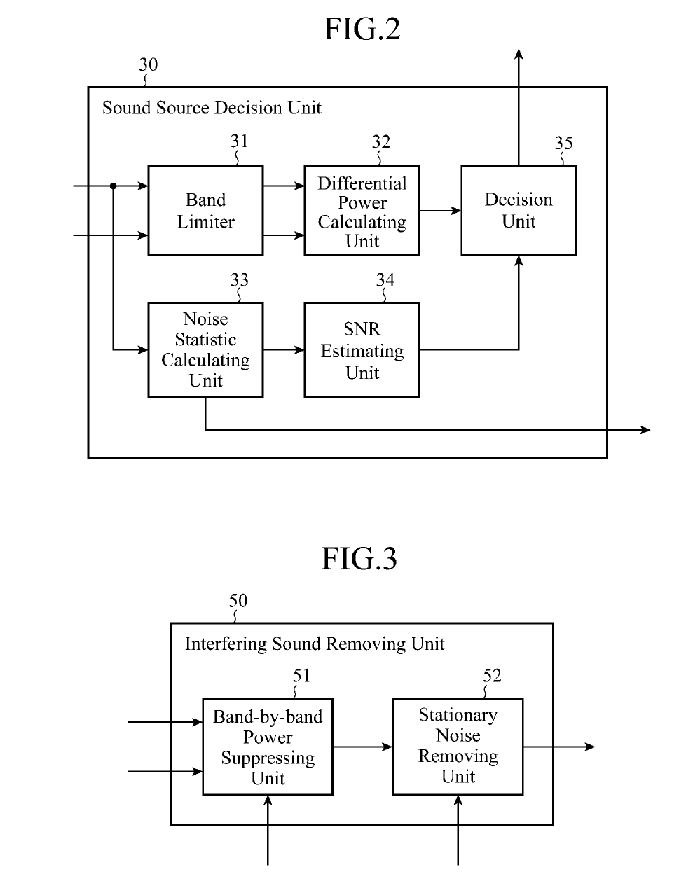

FIG. 2 is a block diagram showing an internal configuration of the sound source decision unit 30 in the noise canceller 1 of the embodiment 1. In FIG. 2, the sound source decision unit 30 comprises a band limiter 31, a differential power calculating unit 32, a noise statistic calculating unit 33, an SNR (signal-to-noise ratio) estimating unit 34, and a decision unit 35.

The band limiter 31 is a section for performing band limitation on the spectrum of the main beam signal and the spectrum of the sub-beam signal, and supplies the band limited power of the main beam signal and that of the sub-beam signal passing through the band limitation to the differential power calculating unit 32.

The differential power calculating unit 32 is a section for computing differential power between the main beam signal and sub-beam signal from the band limited power of the main beam signal and that of the sub-beam signal, and supplies the differential power calculated to the decision unit 35.

The noise statistic calculating unit 33 is a section for computing a statistic of noise from the spectrum of the main beam signal output from the band limiter 31, and supplies the statistic of noise calculated and the spectrum of the main beam signal to the SNR estimating unit 34 and the statistic of noise to the noise spectrum memory 40.

The SNR estimating unit 34 is a section for estimating the current SNR from the spectrum of the main beam signal and the statistic of noise supplied from the noise statistic calculating unit 33, and supplies the SNR estimated to the decision unit 35.

The decision unit 35 is a section for making a decision as to whether the current inputs from the microphones 2 and 3 are voice or stationary noise or unstationary noise from the differential power supplied from the differential power calculating unit 32 and the estimated SNR supplied from the SNR estimating unit 34, and supplies the decision result to the interfering sound removing unit 50 as a sound source decision result.

FIG. 3 is a block diagram showing an internal configuration of the interfering sound removing unit 50 of the noise canceller 1 of the embodiment 1. In FIG. 3, the interfering sound removing unit 50 has a band-by-band power suppressing unit 51 and a stationary noise removing unit 52.

The band-by-band power suppressing unit 51 is a section for comparing, for each band, power of the spectrum of the main beam signal with that of the spectrum of the sub-beam signal output from the frequency analyzing unit 20, and for suppressing, when suppression conditions are satisfied, the power of the corresponding band of the spectrum of the main beam signal. It supplies the spectrum of the main beam signal (suppressed spectrum) after the suppression to the stationary noise removing unit 52.

The stationary noise removing unit 52 is a section for subtracting the average spectrum, which is the statistic of noise stored in the noise spectrum memory 40, from the spectrum of the main beam signal after the suppression supplied from the band-by-band power suppressing unit 51. It outputs the spectrum of the main beam signal after subtracting the average spectrum (suppressed subtraction spectrum).

Incidentally, although it is explained on the assumption that the components of the noise canceller 1, that is, the directivity control unit 10, frequency analyzing unit 20, sound source decision unit 30, noise spectrum memory 40, interfering sound removing unit 50, band limiter 31, differential power calculating unit 32, noise statistic calculating unit 33, SNR estimating unit 34, decision unit 35, band-by-band power suppressing unit 51, and stationary noise removing unit 52 are composed of dedicated circuits as hardware, when the noise canceller 1 is constructed from a computer, it is also possible to store, in a memory of the computer, programs describing the processing contents of the directivity control unit 10, frequency analyzing unit 20, sound source decision unit 30, noise spectrum memory 40, interfering sound removing unit 50, band limiter 31, differential power calculating unit 32, noise statistic calculating unit 33, SNR estimating unit 34, decision unit 35, band-by-band power suppressing unit 51, and stationary noise removing unit 52, and causes the CPU of the computer to execute the programs stored in the memory.

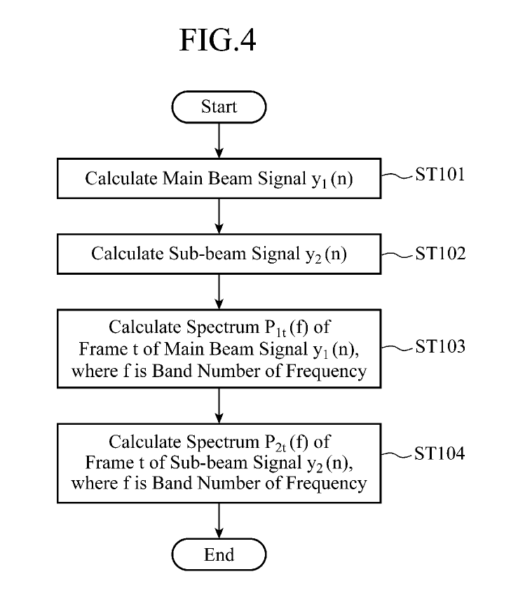

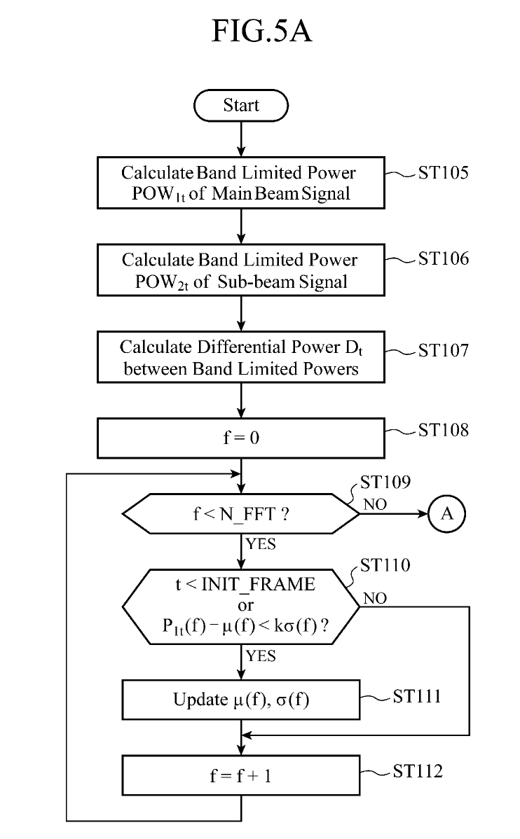

Next, the operation of the noise canceller 1 will be described. FIG. 4 is a flowchart showing the operation of the directivity control unit 10 and frequency analyzing unit 20 of the noise canceller 1. First, when the output signals xₘ(n) (m=1, 2, . . . , M) of the plurality of microphones are input, the directivity control unit 10 calculates the main beam signal y₁(n) according to the following Expression (1) (step ST101). In Expression (1), h₁ₘ(n) denotes a filter coefficient of the main beam for the output signal of the microphone m (microphones 2 and 3 in FIG. 1) and * denotes a convolution algorithm. The directivity control unit 10 learns the filter coefficients h₁ₘ(n) in advance in such a manner as to maintain the sensitivity in the object sound direction while suppressing the sensitivity in the object sound direction. As the learning method, an NLMS method, which is widely known as a learning method of an adaptive filter, can be applied.

Then, the directivity control unit 10 calculates the sub-beam signal y₂(n) according to the following Expression (2) (step ST102). In Expression (2), h₂ₘ(n) denotes a filter coefficient of the sub-beam for the output signal of the microphone m. The directivity control unit 10 learns the filter coefficients h₂ₘ(n) in advance in such a manner as to suppress the sensitivity in the object sound direction while maintaining the sensitivity in the other directions. Incidentally, although the foregoing explanation is made in an order of executing step ST102 after step ST101, step ST101 and step ST102 can be executed in parallel.

$$\begin{matrix}{y}_{1} ( n ) = {\sum }_{m = 1}^{M} {h}_{1 m} ( n ) * {x}_{m} ( n ) & ( 1 ) \\ {y}_{2} ( n ) = {\sum }_{m = 1}^{M} {h}_{2 m} ( n ) * {x}_{m} ( n ) & ( 2 )\end{matrix}$$

Next, as for the input of L samples (L(t−1)≦n≦Lt) in a frame t of the main beam signal y₁(n), the frequency analyzing unit 20 applies a window function such as a Hamming window, followed by calculating a spectrum P₁ₜ(f) of the frame t of the main beam signal by carrying out frequency analysis such as FFT (step ST103), where f is a band number of the frequency.

Likewise, as for the input of L samples (L(t−1)≦n≦Lt) in the frame t of the sub-beam signal y₂(n), the frequency analyzing unit 20 applies a window function such as a Hamming window, followed by calculating a spectrum P₂ₜ(f) of the frame t of the sub-beam signal by carrying out frequency analysis such as FFT (step ST104). Incidentally, although the foregoing explanation is made in an order of executing step ST104 after step ST103, step ST103 and step ST104 can be executed in parallel.

The foregoing is an operation example of the directivity control unit 10 and frequency analyzing unit 20 of the noise canceller 1.

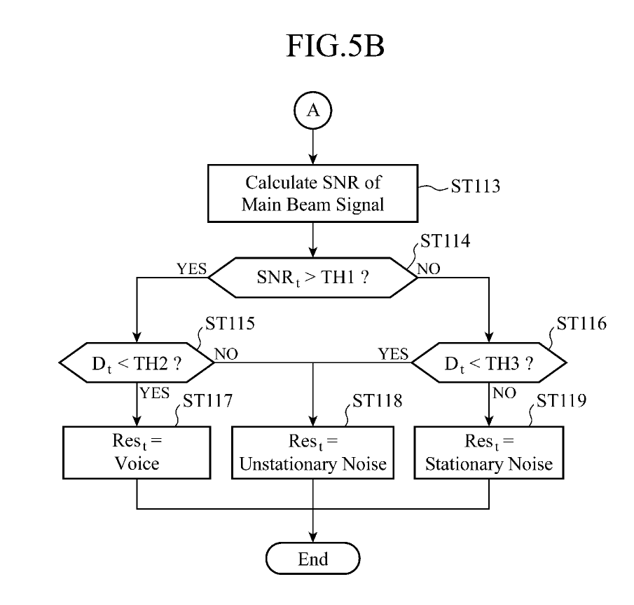

Next, the operation of the sound source decision unit 30 will be described. FIG. 5A and FIG. 5B are a flowchart showing the operation of the sound source decision unit 30 of the noise canceller 1. First, the band limiter 31 calculates the band limited power POW₁ₜ of the main beam signal of the frame t from the spectrum P₁ₜ(f) of the frame t of the main beam signal according to the following Expression (3) (step ST105). In Expression (3), Fₘᵢₙ is the minimum frequency of the band limitation and Fₘₐₓ is the maximum frequency thereof.

Likewise, the band limiter 31 calculates the band limited power POW₂ₜ of the sub-beam signal of the frame t from the spectrum P₂ₜ(f) of the frame t of the sub-beam signal according to the following Expression (4) (step ST106)

$$\begin{matrix}{POW}_{1 t} = {\sum }_{f = F min}^{F max} {P}_{1 t} ( f ) & ( 3 ) \\ {POW}_{2 t} = {\sum }_{f = F min}^{F max} {P}_{2 t} ( f ) & ( 4 )\end{matrix}$$

The differential power calculating unit 32 calculates the differential power Dₜ between the band limited powers of the frame t according to the following Expression (5) (step ST107).

Incidentally, as will be described later, since the differential power D, is used as a parameter for making a decision as to whether the sound source is in the object sound direction or not, it is desirable to set the maximum frequency Fₘₐₓ at the maximum band in which no spatial aliasing will occur, that is, at the maximum band in which the direction is determined uniquely from the time difference. Accordingly, the spatial aliasing Fₘₐₓ can be calculated from the set spacing D_{mic} between the microphones 2 and 3 according to the following Expression (6). In Expression (6), C is the speed of sound (331.5 m/s), SF is a sampling frequency (Hz), and N_FFT is the number of points of FFT.

$$\begin{matrix}{D}_{t} = {POW}_{1 t} - {POW}_{2 t} & ( 5 ) \\ {F}_{max} = \frac{C \times N\_FFT}{2 {D}_{mic} \times SF} & ( 6 )\end{matrix}$$

The noise statistic calculating unit 33 updates the statistic of noise, that is, the average value μ_{f} and standard deviation σ_{f} of the noise spectrum with the frequency number f (the spectrum of the main beam signal corresponding the conditions which will be described later) in the following procedure. The noise statistic calculating unit 33 sets the frequency number f at zero, first (step ST108). If the frequency number f is less than the FFT point number N_FFT (“Yes” at step ST109), the noise statistic calculating unit 33 proceeds to step ST110, otherwise it proceeds to step ST113 (“No” at ST109).

If the frame number t is less than the initialization frame number INIT_FRAME or if it satisfies the condition of P₁ₜ(f)−μ(f)<kσ(f) (“Yes” at step ST110), the noise statistic calculating unit 33 proceeds to step ST111, otherwise it proceeds to step ST112 (“No” step ST110), where k is an update parameter. A large k will increase the trackability for noise fluctuations and a small k will reduce the trackability for the noise fluctuations.

Next, the noise statistic calculating unit 33 updates the average value μ_{f} and standard deviation σ_{f} according to the following Expressions (7)-(13) (step ST111). In Expressions (7)-(13), SUM1(f) and SUM2(f) denote buffers used for addition for the frequency number f, BUFSIZE denotes a frame number as to which the statistic is calculated, cnt (f) denotes a counter of the frequency number f, oldest denotes the oldest frame number added in the buffer used for addition.

$$\begin{matrix}SUM 1 ( f ) = SUM 1 ( f ) - {P}_{1 oldest} ( f ) if cnt ( f ) > BUFSIZE & ( 7 ) \\ SUM 2 ( f ) = SUM 2 ( f ) - {{P}_{1 oldest} ( f )}^{2} if cnt ( f ) > BUFSIZE & ( 8 ) \\ SUM 1 ( f ) = SUM 1 ( f ) + {P}_{1 t} ( f ) & ( 9 ) \\ SUM 2 ( f ) = SUM 2 ( f ) + {{P}_{1 t} ( f )}^{2} & ( 10 ) \\ {μ}_{f} = \frac{SUM 1 ( f )}{min ( cnt ( f ) , BUFSIZE )} & ( 11 ) \\ {σ}_{f} = \sqrt{\frac{SUM 2 ( f )}{min ( cnt ( f ) , BUFSIZE )} - {μ}_{f}^{2}} & ( 12 ) \\ cnt ( f ) = cnt ( f ) + 1 & ( 13 )\end{matrix}$$

The noise statistic calculating unit 33 increments the frequency number f (step ST112), and returns to step ST109.

When the frequency number f is not less than the FFT point number N_FFT (“No” at ST109), the noise statistic calculating unit 33 proceeds to step ST113. At step ST113, the SNR estimating unit 34 estimates the SNRₜ of the frame t of the main beam signal according to the following Expression (14).

$${SNR}_{t} = 10 log \frac{{\sum }_{f = 0}^{N\_FFT} {P}_{1 t} ( f )}{{\sum }_{f = 0}^{N\_FFT} μ ( f )} \qquad ( 14 )$$

The decision unit 35 identifies the sound source in the following procedure. First, if SNR, is greater than a threshold value TH1 (“Yes” step ST114), the decision unit 35 proceeds to step ST115, otherwise it proceeds to step ST116 (“No” at step ST114).

The decision unit 35 substitutes “voice” into the sound source decision result Resₜ when SNRₜ is greater than the threshold value TH1 and the differential power Dₜ is less than a threshold value TH2 (“Yes” at step ST115) (step ST117), and substitutes “unstationary noise” into the sound source decision result Resₜ when SNRₜ is greater than the threshold value TH1 and the differential power Dₜ is not less than the threshold value TH2 (“No” at step ST115) (step ST118).

On the other hand, the decision unit 35 substitutes “unstationary noise” into the sound source decision result Resₜ when SNRₜ is not greater than the threshold value TH1 and the differential power Dₜ is less than the threshold value TH3 (“Yes” at step ST116) (step ST118), and substitutes “stationary noise” into the sound source decision result Resₜ when SNRₜ is not greater than the threshold value TH1 and the differential power Dₜ is not less than a threshold value TH3 (“No” at step ST116) (step ST119).

The foregoing is an example of the operation of the sound source decision unit 30 of the noise canceller 1.

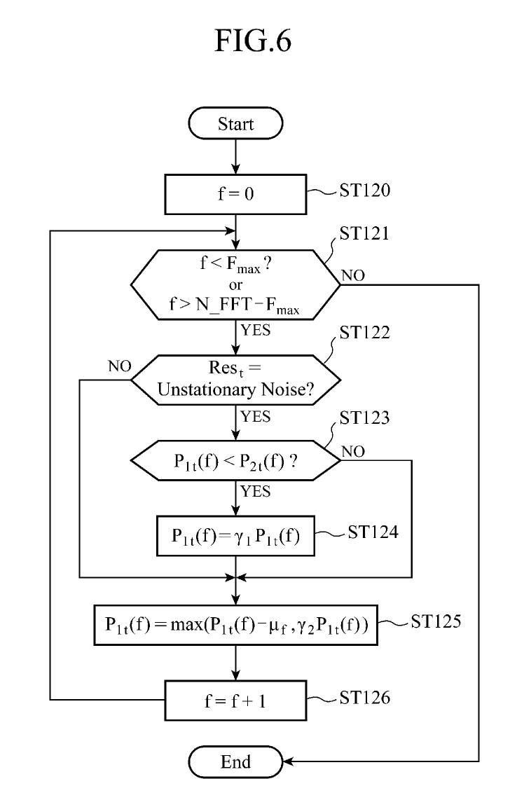

Next, the operation of the interfering sound removing unit 50 will be described. FIG. 6 is a flowchart showing the operation of the interfering sound removing unit 50 of the noise canceller 1. The band-by-band power suppressing unit 51 sets the frequency number f at zero, first (step ST120).

If the frequency number f is less than the maximum frequency Fₘₐₓ or greater than N_FFT−Fₘₐₓ (“Yes” at step ST121), the band-by-band power suppressing unit 51 proceeds to step ST122, otherwise it terminates the interfering sound removing processing (“No” at step ST121).

If the sound source decision result Resₜ output from the sound source decision unit 30 is “unstationary noise” (“Yes” at step ST122), the band-by-band power suppressing unit 51 proceeds to step ST123 to execute processing of suppressing the power of the corresponding band of the main beam signal, otherwise (“No” at ST122) it proceeds to ST125.

In addition, the band-by-band power suppressing unit 51 compares the spectrum P₁ₜ(f) of the main beam signal output from the frequency analyzing unit 20 with the spectrum P₂ₜ(f) of the sub-beam signal output therefrom (suppression condition, step ST123). If the spectrum of the sub-beam signal P₂ₜ(f) is greater (“Yes” at step ST123), it proceeds to step ST124, otherwise (“No” at step ST123) it proceeds to step ST125.

If P₁ₜ(f)<P₂ₜ(f) (“Yes” at step ST123), the band-by-band power suppressing unit 51 decides that the interfering sound component is greater for the frequency number f, and suppresses the spectrum of the main beam signal P₁ₜ(f) according to the following Expression (15) (step ST124). In Expression (15), γ₁ is a suppression coefficient.

P_{1f}(f)=γ₁P_{1f}(f) (15)

Next, the stationary noise removing unit 52 removes the stationary noise from the spectrum of the main beam signal P₁ₜ(f) passing through the suppression by using the average value μ_{f} of the noise spectrum output from the noise spectrum memory 40 according to the following Expression (16) (step ST125). In Expression (16), γ₂ is a flooring coefficient.

P_{1f}(f)=max(P_{1f}(f)−μ_{f},γ₂P_{1f}(f)) (16)

Finally, the stationary noise removing unit 52 increments the frequency number f (step ST126), and returns to step ST121.

The foregoing is an example of the operation of the interfering sound removing unit 50 of the noise canceller 1.

As described above, according to the embodiment 1, since it is configured in such a manner that the directivity control unit 10 controls the directivity of the output signals of the plurality of microphones by the signal processing, the sound source decision unit 30 can compare the main beam signal which is the emphasized object sounds with the sub-beam signal which is the interfering sounds in which the object sounds are suppressed, thereby being able to make the power difference distinct as compared with the conventional method. As a result, it can improve the noise cancellation capacity of the interfering sound removing unit 50.

In addition, since the directivity control unit 10 controls the directivity through the signal processing, even if the object sound direction alters, it can carry out the noise cancellation without changing the set positions of the microphones 2 and 3.

Furthermore, since the band-by-band suppression processing is performed on only frames as to which the sound source decision unit 30 makes a decision of the unstationary noise, it can prevent the frequency characteristics of the object voice from being distorted.

Moreover, since the interfering sound removing unit 50 removes the interfering sounds using the statistic of noise stored in the noise spectrum memory 40, it can remove the noise even if the noise is superposed on the object sounds and the bands selected.

### Embodiment 2

The noise canceller 1 of the foregoing embodiment 1 supposes that the object sound direction is fixed in one direction. Accordingly, it cannot remove the noise correctly if the object sound direction varies as when a talker moves. The object of the present embodiment 2 is to solve such a problem.

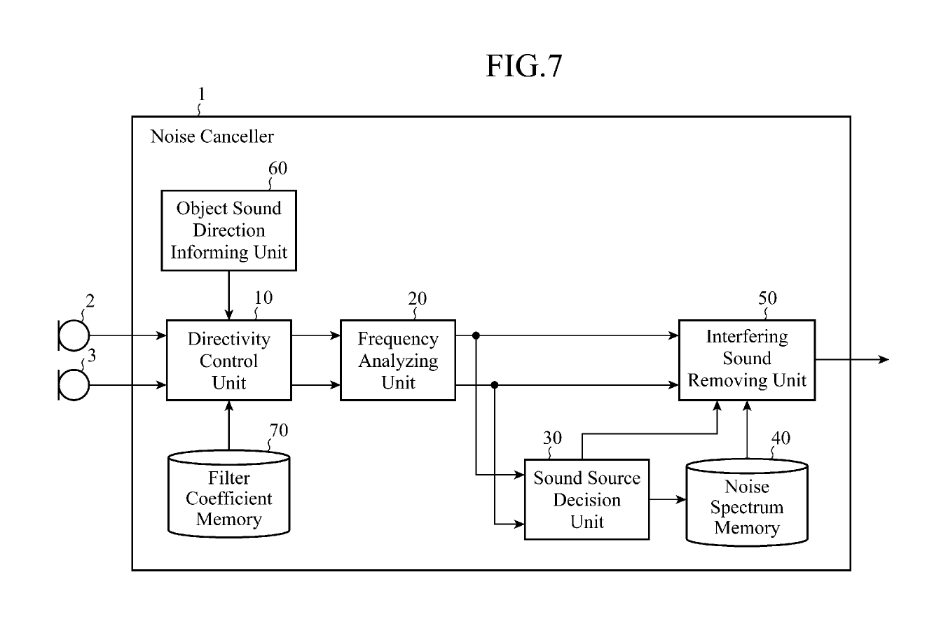

FIG. 7 is a block diagram showing a configuration of the noise canceller 1 of the embodiment 2 in accordance with the present invention. In FIG. 7, an object sound direction informing unit 60 and a filter coefficient memory 70 are newly provided in addition to the components of FIG. 1. In FIG. 7, the same or like components to those of FIG. 1 are designated by the same reference numerals and their description will be omitted.

The object sound direction informing unit 60 is a section for deciding the object sound direction from an external input such as a sensor (not shown) and for notifying of it, and supplies the object sound direction to the directivity control unit 10. The filter coefficient memory 70 is a section for storing the filter coefficients for forming the main beam and sub-beam corresponding to each object sound direction, and supplies the filter coefficients corresponding to the object sound direction to the directivity control unit 10. Incidentally, as for the filter coefficients to be stored in the filter coefficient memory 70, they are learned in advance in accordance with the object sound directions supposed.

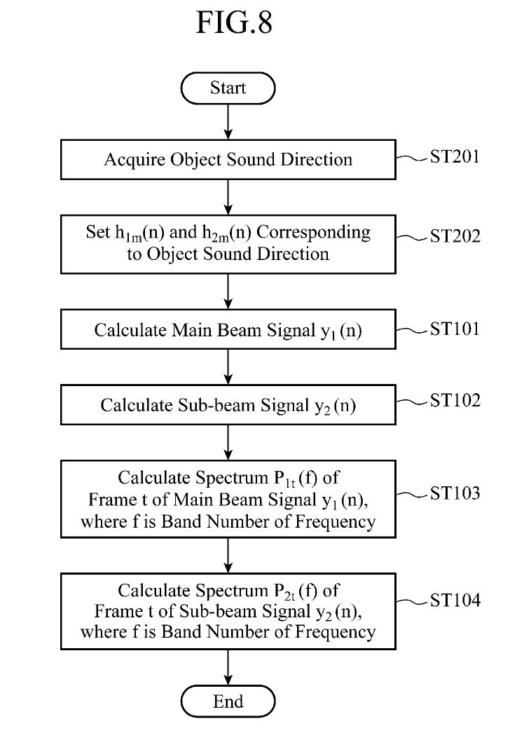

Next, the operation of the noise canceller 1 will be described. FIG. 8 is a flowchart showing the operation of the object sound direction informing unit 60, directivity control unit 10 and frequency analyzing unit 20 of the noise canceller 1. As for the same steps as those of the noise canceller of the embodiment 1, their explanation will be omitted by using the same reference symbols as those of the flowcharts of FIG. 4-FIG. 6.

First, the object sound direction informing unit 60 decides the object sound direction from the external input such as a sensor. For example, when the noise canceller 1 operates in the vehicle, it acquires the steering wheel set direction of the vehicle from the car navigation system, and makes the direction the object sound direction (step ST201). Then the object sound direction informing unit 60 notifies the directivity control unit 10 of the object sound direction.

Next, the directivity control unit 10 acquires from the filter coefficient memory 70 the filter coefficients corresponding to the object sound direction notified by the object sound direction informing unit 60, and sets them to the filter coefficients h₁ₘ(n) and h₂ₘ(n) of the main beam and sub-beam for the output signal of the microphone m (ST202). Although the directivity control unit 10 executes the processing using these filter coefficients thereafter, since the following operation is the same as that of the foregoing embodiment 1, the description thereof will be omitted.

As described above, according to the embodiment 2, since the directivity control unit 10 is configured in such a manner as to control the directivity using the filter coefficients corresponding to each object sound direction, it can carry out noise cancellation correctly even if the object sound direction is not one direction and is not fixed.

### Embodiment 3

The noise cancellers 1 of the foregoing embodiments 1 and 2 do not consider uses after the noise cancellation. However, when using the noise canceller 1 for preprocessing of the voice recognition, for example, it can sometimes perform nonlinear processing of the frequency characteristics due to interfering sound removal depending on a language, which can cause a mismatch with an acoustic model, thereby exerting a bad influence upon the recognition performance. The object of the present embodiment 3 is to solve such a problem.

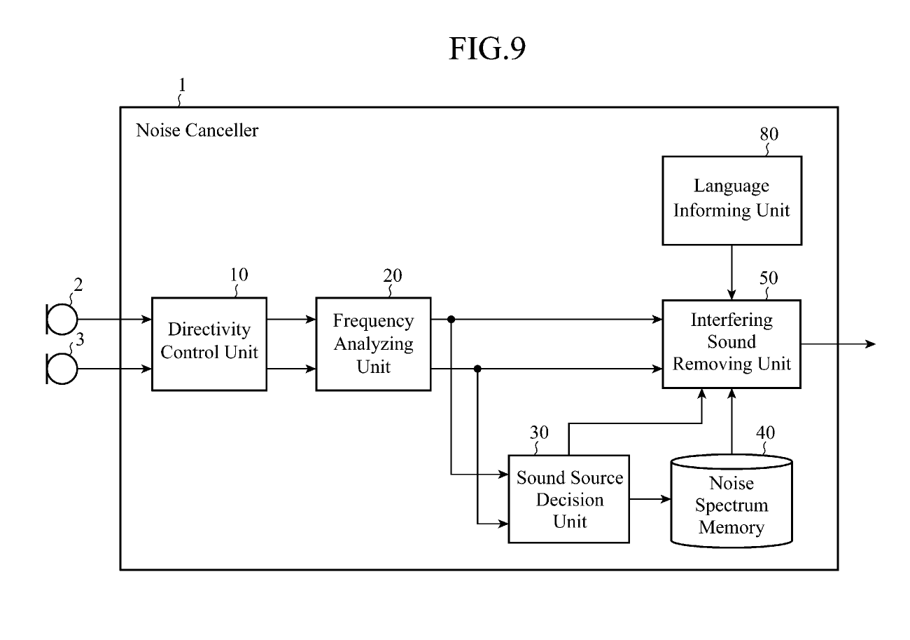

FIG. 9 is a block diagram showing a configuration of the noise canceller 1 of the embodiment 3 in accordance with the present invention. In FIG. 9, a language informing unit 80 is newly provided in addition to the components of FIG. 1. In FIG. 9, the same or like components to those of FIG. 1 are designated by the same reference numerals and their description will be omitted.

The language informing unit 80 is a section for acquiring a language used from a device connected to a post-stage of the noise canceller 1 and informs of it, and supplies a kind of language of the voice input from the microphones 2 and 3 to the interfering sound removing unit 50.

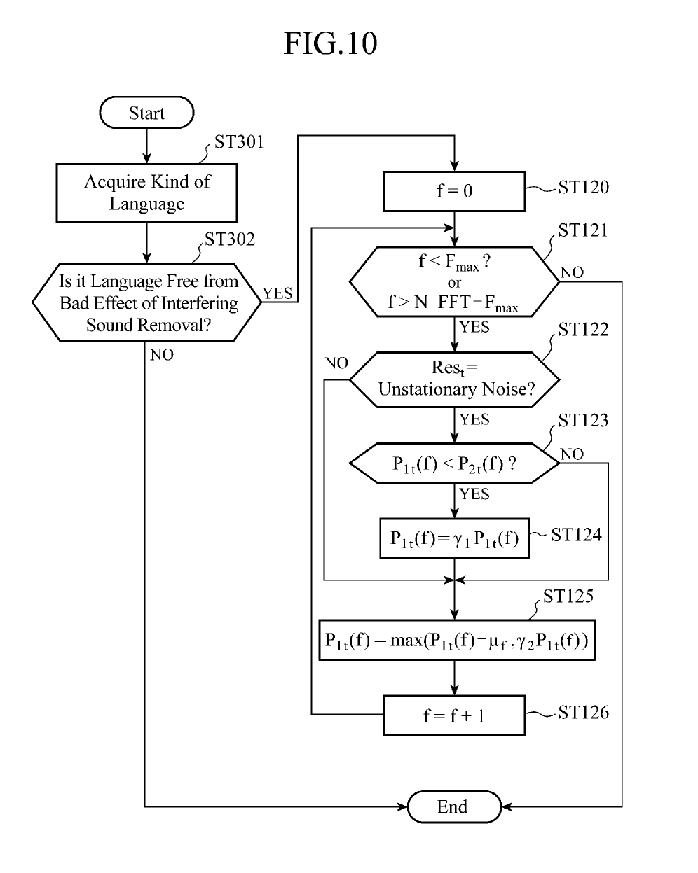

Next, the operation of the noise canceller 1 will be described. FIG. 10 is a flowchart showing the operation of the language informing unit 80 and interfering sound removing unit 50 of the noise canceller 1. As for the same steps as those of the noise canceller of the embodiment 1, their explanation will be omitted by using the same reference symbols as those of the flowcharts of FIG. 4-FIG. 6.

Before the operation of the interfering sound removing unit 50 (steps ST120-ST126), the language informing unit 80 acquires information about the language used from the device connected to the post-stage. For example, when the noise canceller 1 operates in the vehicle, a voice recognition unit in the car navigation system is connected to a post-stage. Thus, the language informing unit 80 acquires the language used from the car navigation system or voice recognition unit (step ST301).

The interfering sound removing unit 50 makes a decision as to whether the kind of language notified is a language receiving no band effect from the interfering sound removal (or a language receiving little effect from the interfering sound removing processing) or not, first. The interfering sound removing unit 50 maintains a corresponding relationship between the language used and the effect of the interfering sound removing processing, and as for the language receiving no bad effect (“Yes” at step ST302), it proceeds to step ST120, and as for the language receiving bad effect (“No” at step ST302), it skips the interfering sound removing processing and terminates. Since the processing at step ST120 and after is the same as that of the foregoing embodiment 1, the description thereof will be omitted.

As described above, according to the embodiment 3, since it is configured in such a manner that the interfering sound removing unit 50 skips the interfering sound removing processing for the language that receives a bad effect on its recognition performance owing to a mismatch with the acoustic model, which the interfering sound removal brings about in the nonlinear processing of the frequency characteristics. Accordingly, it can prevent the bad effect beforehand, and carry out the noise cancellation correctly even when the language that will receive the effect of the interfering sound removal is input.

### Embodiment 4

The noise cancellers 1 of the foregoing embodiments 1-3 are configured in such a manner as to compare the power of the main beam and the power of the sub-beam for each band for the frame as to which a decision of the unstationary noise is made, and to perform noise suppression of the band in which the power of the sub-beam is greater. However, since the sound source decision unit 30 limits the band to be subjected to the suppression by the maximum frequency Fₘₐₓ, the suppression is performed only part of the used bands depending on the set spacing between the microphones 2 and 3, thereby being unable to achieve sufficient noise suppression performance. The object of the present embodiment 4 is to solve such a problem.

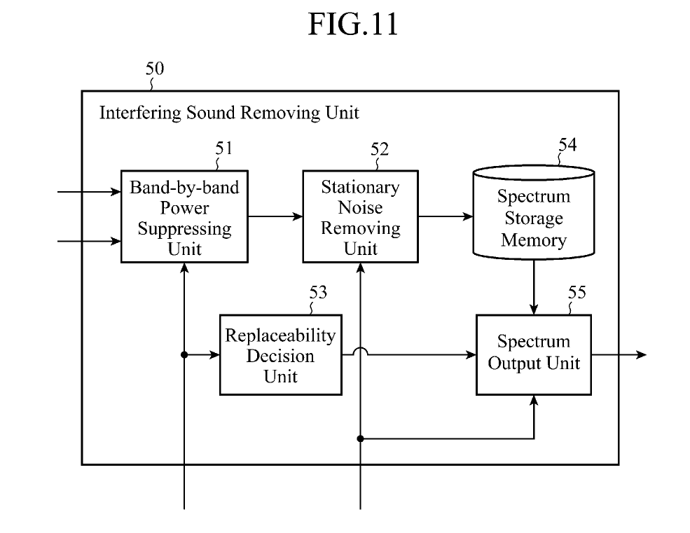

FIG. 11 is a block diagram showing an internal configuration of the interfering sound removing unit 50 of the noise canceller 1 of the embodiment 4 in accordance with the present invention. In FIG. 11, a replaceability decision unit 53, a spectrum storage memory 54, and a spectrum output unit 55 are newly added to the components of FIG. 3. Incidentally, since the noise canceller 1 of the present embodiment has the same configuration on the drawing as the noise canceller 1 of the foregoing embodiment 1 shown in FIG. 1, the following description will be made with the help of FIG. 1.

The replaceability decision unit 53 is a section for deciding the necessity for the spectrum replacement in accordance with the sound source decision result of the sound source decision unit 30, and supplies the replaceability decision result to the band-by-band power suppressing unit 51 and spectrum output unit 55. The spectrum storage memory 54 is a section for storing the spectrum of the main beam signal supplied from the stationary noise removing unit 52 for a given time period, and supplies the stored spectrum to the spectrum output unit 55 as needed. The spectrum output unit 55 is a section for outputting the spectrum passing through the interfering sound suppression of the main beam signal, which is the final processing result of the stationary noise removing unit 52. It outputs the spectrum obtained by attenuating the average spectrum of the noise stored in the noise spectrum memory 40 when the replaceability decision unit 53 makes a decision that the replacement of the spectrum before the given time period is possible. In contrast, when a decision is made that the replacement is impossible, it outputs the spectrum of the main beam signal before the given time period, which is stored in the spectrum storage memory 54.

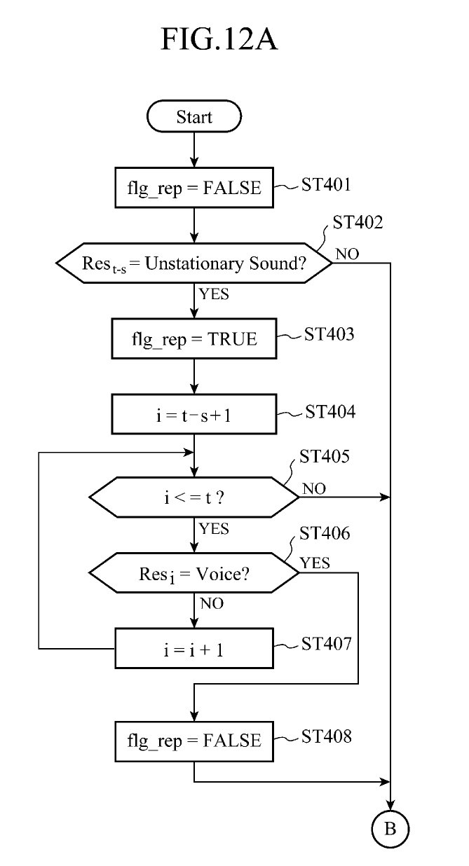

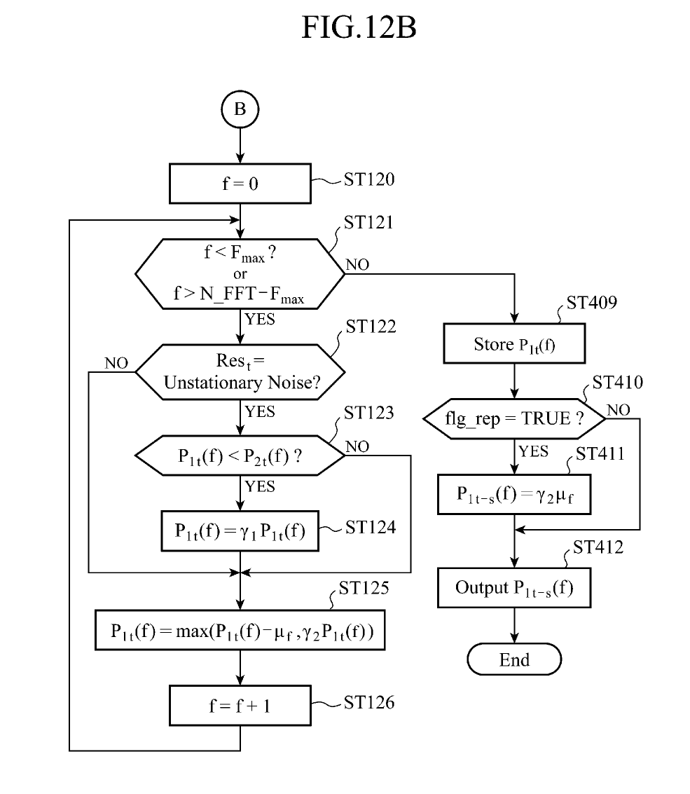

Next, the operation of the noise canceller 1 will be described. FIG. 12A and FIG. 12B are a flowchart showing the operation of the interfering sound removing unit 50 of the noise canceller 1. As for the same steps as those of the noise canceller 1 of the foregoing embodiment 1, they are designated by the same symbols as those in the flowcharts of FIG. 4-FIG. 6 and their description will be omitted.

First, the replaceability decision unit 53 executes the replaceability decision processing of the spectrum s-frames before in the following procedure. First, the replaceability decision unit 53 substitutes FALSE into a flag flg_rep which indicates whether the replacement is possible or not as to the spectrum s-frames before (step ST401).

Next, if the sound source decision result Resₜ₋ₛ of the frame s-frames before a frame t, that is, of the (t−s) frame is “unstationary noise” (“Yes” at step ST402), the replaceability decision unit 53 proceeds to step ST403, otherwise (“No” at step ST402) it proceeds to step ST120.

If the sound source decision result Resₜ₋ₛ is “unstationary noise” (“Yes” at step ST402), the replaceability decision unit 53 substitutes TRUE into the flag flg_rep (step ST403), and substitutes (t−s+1) into the counter i (step ST404).

Subsequently, if the counter i is not greater than frame t (“Yes” at step ST405), the replaceability decision unit 53 proceeds to step ST406, otherwise (“No” at step ST405) it proceeds to step ST120.

If the sound source decision result Resₜ of the counter i is voice (“Yes” at step ST406), the replaceability decision unit 53 proceeds to step ST408, otherwise (“No” at step ST406) it increments the counter i (step ST407), and returns to step ST405.

If the sound source decision result Resᵢ of the counter i is voice (“Yes” at step ST406), the replaceability decision unit 53 substitutes FALSE into the flag flg_rep (step ST408), and proceeds to step ST120.

The foregoing is an example of the operation of the replaceability decision unit 53.

As for the processing at step ST120-ST126, since it is the same as that of the foregoing embodiment 1, the description thereof will be omitted here. Only it differs in that unless f<Fₘₐₓ or f>N_FFT−Fₘₐₓ is satisfied in the processing of the band-by-band power suppressing unit 51 at step ST121, the processing proceeds to step ST409. At step ST409, the spectrum storage memory 54 stores the spectrum of the main beam signal P₁ₜ(f) output from the stationary noise removing unit 52.

Next, the spectrum output unit 55 outputs a spectrum in the following procedure. First, if the flag flg_rep, which is the replaceability decision result of the replaceability decision unit 53, is TRUE (“Yes” at step ST410), the spectrum output unit 55 proceeds to step ST411. Otherwise (“No” step ST410), it proceeds to step ST412.

Next, the spectrum output unit 55 calculates a spectrum (spectrum based on the statistic of noise) by attenuating the average spectrum of the noise stored in the noise spectrum memory 40 according to the following Expression (17) (step ST411). Then, the spectrum output unit 55 outputs the spectrum P₁ₜ₋ₛ(f) based on Expression (17) in place of the spectrum of the main beam signal stored in the spectrum storage memory 54 (step ST412).

P₁ₜ₋ₛ(f)=γ₂μ_{f} (17)

Incidentally, if the decision at step ST410 is “No” (that is, if the sound source decision result is “unstationary noise” and if the decision is made that the replacement is impossible) and hence step ST411 is skipped to proceed to step ST412, the spectrum output unit 55 does not perform replacement, but outputs the spectrum of the main beam signal P₁ₜ₋ₛ(f) s-frames before, which is stored in the spectrum storage memory 54, without change.

The foregoing is an example of the operation of the interfering sound removing unit 50 of the embodiment 4.

In this embodiment 4, although the value s is preferably as small as possible because the output delays by s-frames with respect to the input, it is necessary to consider that a bad effect can occur such as an initial position of the voice is lost when the value s approaches zero.

As described above, according to the embodiment 4, since it is configured in such a manner that the spectrum output unit 55 replaces the frame of the main beam signal spectrum as to which the replaceability decision unit 53 makes a decision of the unstationary noise by the average spectrum of the noise, it can carry out the noise cancellation for all the bands even if the band which becomes a band-by-band suppression target is narrow owing to the wide set spacing between the microphones 2 and 3. In addition, that the past s-frames do not contain voice is a replacement condition, it can prevent the initial position of the speech from being lost.

Incidentally, although the example of applying the foregoing embodiments 2-4 to the configuration shown in the foregoing embodiment 1, this is not essential. For example, it can also be applied to an appropriate combination of the configurations from the foregoing embodiments 2-4.

### INDUSTRIAL APPLICABILITY

As described above, although its application is not limited to a particular use, a noise canceller in accordance with the present invention is particularly suitable for improving voice recognition performance or telephone conversation quality in a noise environment such as of car navigation systems, mobile phones, information terminals and the like, and is suitable for the application to a talker adaptive device.

What is claimed is:

1. A noise canceller comprising:
a directivity control unit for calculating a main beam signal with its directivity turned toward an object sound direction and a sub-beam signal with its blind spot turned toward the object sound direction from output signals of a plurality of microphones through signal processing;
a frequency analyzing unit for calculating a spectrum of the main beam signal and a spectrum of the sub-beam signal by applying frequency analysis to the main beam signal and the sub-beam signal the directivity control unit calculates;
a sound source decision unit for deciding a type of a sound source from the spectrum of the main beam signal and the spectrum of the sub-beam signal the frequency analyzing unit calculates, for outputting the type of the sound source as a sound source decision result, and for calculating a statistic of noise for the main beam signal; and
an interfering sound removing unit for removing interfering sounds from the spectrum of the main beam signal by using the spectrum of the sub-beam signal the frequency analyzing unit calculates and the sound source decision result and the statistic of noise supplied from the sound source decision unit.

2. The noise canceller according to claim 1, further comprising:
a filter coefficient memory for storing filter coefficients for controlling directivity of the main beam signal and directivity of the sub-beam signal with the filter coefficients being related to object sound directions; and
an object sound direction informing unit for acquiring information about the object sound direction, and for notifying the directivity control unit of the information, wherein
the directivity control unit selects from the filter coefficient memory the filter coefficients corresponding to the object sound direction informed by the object sound direction informing unit, and calculates the main beam signal and sub-beam signal from the output signals from the plurality of microphones using the filter coefficients.

3. The noise canceller according to claim 1, further comprising:
a language informing unit for acquiring information about a kind of language of target voice to be processed which is contained in the output signals of the plurality of microphones, and notifies the interfering sound removing unit of the information, wherein
the interfering sound removing unit makes a decision about necessity for interfering sound removing processing in accordance with the kind of language informed by the language informing unit.

4. The noise canceller according to claim 1, wherein the sound source decision unit comprises:
a band limiter for performing band limitation on the spectrum of the main beam signal and the spectrum of the sub-beam signal;
a differential power calculating unit for calculating differential power from the spectrum of the main beam signal and the spectrum of the sub-beam signal passing through the band limitation by the band limiter;
a noise statistic calculating unit for calculating a statistic of noise from the spectrum of the main beam signal;
an SNR estimating unit for estimating a current signal-to-noise ratio from the spectrum of the main beam signal and the statistic of noise; and
a decision unit for deciding on whether the current output signals of the microphones are voice, stationary noise or unstationary noise from the differential power the differential power calculating unit calculates and from the signal-to-noise ratio the SNR estimating unit estimates, and for outputting the decision result as a sound source decision result.

5. The noise canceller according to claim 1, wherein the interfering sound removing unit comprises:
a band-by-band power suppressing unit for comparing power of the spectrum of the main beam signal and power of the spectrum of the sub-beam signal for each band, and for suppressing, when a prescribed suppression condition is satisfied, power of a corresponding band of the main beam signal; and
a stationary noise removing unit for subtracting the statistic of noise from the suppressed spectrum of the main beam signal passing through the suppression by the band-by-band power suppressing unit.

6. The noise canceller according to claim 5, wherein the interfering sound removing unit comprises:
a spectrum storage memory for storing the suppressed subtraction spectrum of the main beam signal passing through the subtraction by the stationary noise removing unit for a given time period;
a replaceability decision unit for deciding on whether the suppressed subtraction spectrum of the given time period before, which is stored in the spectrum storage memory, is to be replaced by the spectrum based on the statistic of noise or not in accordance with the sound source decision result supplied from the sound source decision unit; and
a spectrum output unit for outputting the spectrum based on the statistic of noise when the replaceability decision unit makes a replaceable decision, and for outputting the suppressed subtraction spectrum of the given time period before, which is stored in the spectrum storage memory when the replaceability decision unit makes an irreplaceable decision.

7. A noise cancellation program for causing a computer to function as:
a directivity control unit for calculating a main beam signal with its directivity turned toward an object sound direction and a sub-beam signal with its blind spot turned toward the object sound direction from output signals of a plurality of microphones through signal processing;
a frequency analyzing unit for calculating a spectrum of the main beam signal and a spectrum of the sub-beam signal by applying frequency analysis to the main beam signal and the sub-beam signal the directivity control unit calculates;
a sound source decision unit for deciding a type of a sound source from the spectrum of the main beam signal and the spectrum of the sub-beam signal the frequency analyzing unit calculates, for outputting the type of the sound source as a sound source decision result, and for calculating a statistic of noise for the main beam signal; and
an interfering sound removing unit for removing interfering sounds from the spectrum of the main beam signal by using the spectrum of the sub-beam signal the frequency analyzing unit calculates and the sound source decision result and the statistic of noise supplied from the sound source decision unit.
